(19) United States
(12) Patent Application Publication
(10) Pub. No.: US 2012/0208156 A1
(43) Pub. Date: Aug. 16, 2012

(54) Exercise Encouragement Device

(76) Inventor: Adam Rocklin, Littleton, CO (US)

(21) Appl. No.: 13/396,594

(22) Filed: Feb. 14, 2012

Related U.S. Application Data
(60) Provisional application No. 61/463,207, filed on Feb. 14, 2011.

(51) Int. Cl. G09B 19/00

(52) U.S. Cl. 434/236

(57) ABSTRACT

An exercise encourage device can be clipped onto a child's apparel or an object worn about the person such as shoes, belt, shirt, pants pocket, etc. The device contains a motion-activated mechanism that initiates the device in response to activity by the child. Exemplary activities are running, jumping, skipping, dancing, etc. When a child engages in an energetic activity, this causes the device to flash with light and play a sound track which encourages the child to continue the activity. Exemplary sound tracks include sounds associated with a race car, a fire engine, horses, puppies and kittens. Other sound tracks are contemplated. Ongoing activity continues to activate the device, but if the child stops, the device deactivates until an energetic activity is resumed.

### CROSS-REFERENCE TO RELATED APPLICATIONS

The application claims benefit of U.S. Provisional Application No. 61/463,207 entitled “Exercise Encouragement Device” and filed on Feb. 14, 2011, which is specifically incorporated by reference herein for all that it teaches and discloses.

### TECHNICAL FIELD

The invention relates generally to the field of exercise equipment and related devices, and more particularly to an exercise encouragement device.

### BACKGROUND

Unfortunately, childhood obesity is becoming a widespread problem in the United States and elsewhere. Children are bombarded with advertisements for high-calorie/high-fat foods targeted specifically at kids. Calorie-rich drinks and foods are readily available to children and it seems that society even encourages children to choose sugar-laden soft drinks, candy, and fast food over healthier alternatives. For example, many advertisements for the soft drink industry target kids and calorie-dense, prepared snacks are sold to parents to send with their kids as “packed lunches” instead of eating a more balanced, hot meal. As childhood obesity has become more prevalent, snack vending machines in school settings have been reduced by law in a small number of localities. And yet, there has also been a trend towards “open” lunch periods which allow children to leave the school setting and seek food from nearby restaurants, etc. Not surprisingly, a study found that fast food restaurants near schools increases the risk of obesity among the student population. The fast food industry spends over $40 billion on advertisements aimed at young children. One popular fast food restaurant alone has thirteen web sites that are viewed by 365,000 children and 294,000 teenagers each month. In addition, fast food restaurants give out toys in children's meals, further enticing children.

Compounding the problem, more and more activities for kids are centered around indoor, sedentary pursuits such as video games, texting, browsing the internet, television, movies, etc. Just as in adults, when kids consume more calories than they burn off through exercise, the excess is stored as fat and as the consumption/burn ratio climbs higher, childhood obesity can result. Due to the rising prevalence of childhood obesity and its many adverse health effects it is being recognized as a serious public health concern.

Although there are many physical problems that can develop in overweight or obese children, the first problems to occur are often emotional or psychological. Obese children often suffer from teasing and abuse by other children. Some children are even harassed or discriminated against by their own family “Fat-kid” stereotypes are common and may lead to low self esteem and depression. As the childhood obesity persists, it can also lead to life-threatening physical conditions including diabetes, high blood pressure, heart disease, sleep problems, and other disorders, including: liver disease, early puberty or menarche, eating disorders such as anorexia and bulimia, skin infections, and asthma and other respiratory problems. Finally, when a child is overweight or obese, that child is more likely to grow up to be an overweight adult, with all the attendant physical, emotion, and societal difficulties.

Fortunately, because there is a growing awareness of this epidemic, efforts are being made to address the situation. For example, many video games are becoming more interactive and require running, dancing, and other movements. Nevertheless, such changes, although positive, are not getting kids up and outside to run and play. Thus, a need still exists for exercise inducement devices that encourage kids to be more active, and more specifically, that provide positive and desirable auditory and visual feedback when a child engages in exercise activities such as running.

### SUMMARY

One embodiment of the present invention is a device that can be clipped onto a child's apparel (such as shoes, belt, shirt, pants pocket, etc.). The device contains a motion-activated mechanism that initiates the device in response to activity by the child. Exemplary activities are running, jumping, skipping, dancing, etc. When a child engages in an energetic activity, this causes the device to flash with light and play a sound track which encourages the child to continue the activity. Exemplary sound tracks include sounds associated with a race car, a fire engine, horses, and puppies and kittens. Other sound tracks are contemplated. Ongoing activity continues to activate the device, but if the child stops, the device deactivates until an energetic activity is resumed.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of an exercise encouragement device in accordance with an aspect of the present invention;

FIG. 2 illustrates an exploded view of an exemplary embodiment of an exercise encouragement device;

FIG. 3A illustrates a top plan view of an exemplary embodiment of an exercise encouragement device;

FIG. 3B illustrates an elevational view of the top sidewall of an exemplary embodiment of an exercise encouragement device;

FIG. 3C illustrates an elevational view of the left sidewall of an exemplary embodiment of an exercise encouragement device;

FIG. 4A illustrates an elevational view of the left side of an exemplary embodiment of the clip portion of an exercise encouragement device;

FIG. 4B illustrates a top plan view of an exemplary embodiment of the clip portion of an exercise encouragement device;

FIG. 4C illustrates a perspective view of the right side and top of an exemplary embodiment of the clip portion of an exercise encouragement device;

FIG. 5A illustrates a perspective view of the top of an exemplary embodiment of the printed circuit board of an exercise encouragement device; and

FIG. 5B illustrates a perspective view of the top of an exemplary embodiment of the printed circuit board of an exercise encouragement device.

### DETAILED DESCRIPTION

Referring now to the drawings, exemplary embodiments of the invention are described below in the accompanying Figures. The following detailed description provides a comprehensive review of the drawings in order to provide a thorough understanding of, and an enabling description for, these embodiments. One having ordinary skill in the art will understand that the invention may be practiced without certain details. In other instances, well-known structures and functions have not been shown or described in detail to avoid unnecessarily obscuring the description of the embodiments.

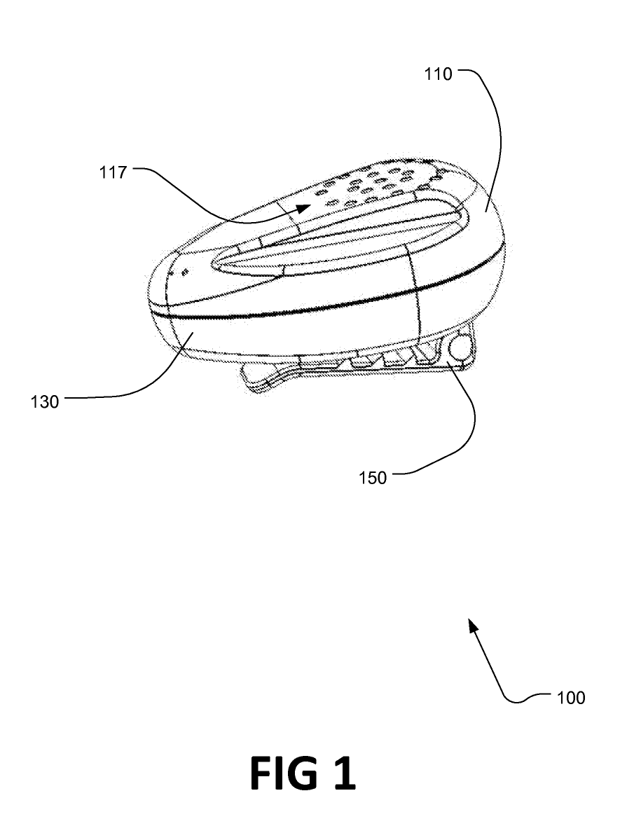

Referring now to the drawings, FIG. 1 illustrates a perspective view of an exemplary embodiment of an exercise encouragement device 100 in accordance with an aspect of the present invention. The exercise encouragement device 100 depicted in FIG. 1 includes an upper case 110, a lower case 130, and a clip portion 150. The upper case 110 works in combination with the lower case 130 to protect and contain the internal components of the exercise encouragement device 100. When the upper case 110 is attached to the lower case 130 they form a combination case. The upper case 110 has a plurality of sound holes 117 in proximity to the sound device or speaker that is located inside the device 100. The speaker can be attached to the upper case 110 and the assembly can be made water resistant with a seal between the speaker and other internal components.

The upper case 110 is shown as being constructed using an opaque material for ease of illustration. In a preferred embodiment, the upper case 110 will be at least partially translucent or transparent so as to allow the lights or illumination located inside the device to be visible from the outside. In other embodiments, illuminating devices are attached on the exterior of the upper case 110 and/or lower case 130.

The lower case 130 attaches to the upper case 110 and helps to protect and contain the inner components. In proximity to the lower case 130 and attached thereto is the clip portion 150. The clip portion 150 allows the exercise encouragement device 100 to be attached to apparel, book bags, shoe laces, and other items that are worn or carried by a person or are otherwise on the user's person.

The internal components are not illustrated in FIG. 1 (see other FIGs). Nevertheless, the components work together to cause the device 100 to function to encourage the wearer to exercise. This is generally accomplished by providing positive feedback in the form of audio and/or visual feedback that is influenced by the motion of the exercise encourage device 100. As the user carries the device 100 around, he or she causes internal movement/acceleration sensing device(s) in the device 100 to activate which in turn activate audio and/or visual feedback that encourages the user to continue to move or even accelerate their movements.

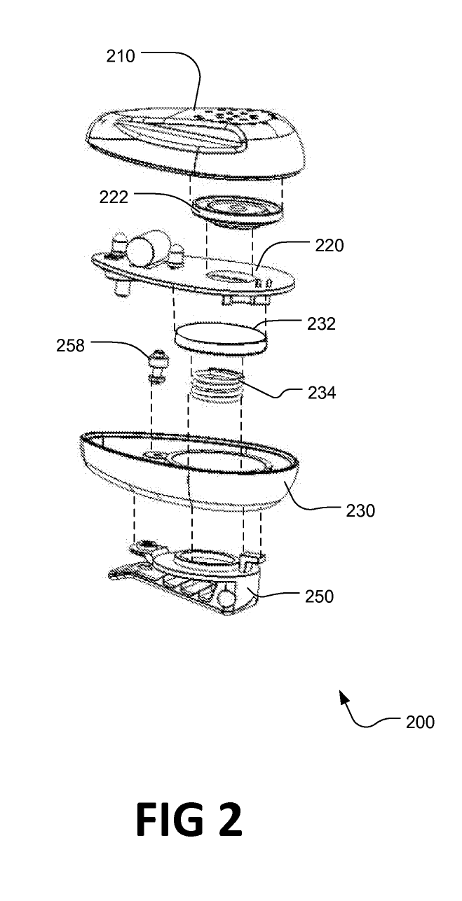

FIG. 2 illustrates an exploded view of an exemplary embodiment of an exercise encouragement device 200. The exemplary components illustrated in FIG. 2 include the upper case 210, a printed circuit board 220, a sound device/speaker 222, the lower case 230, a power source 232, a spring 234, an attachment screw 258, and a clip portion 250.

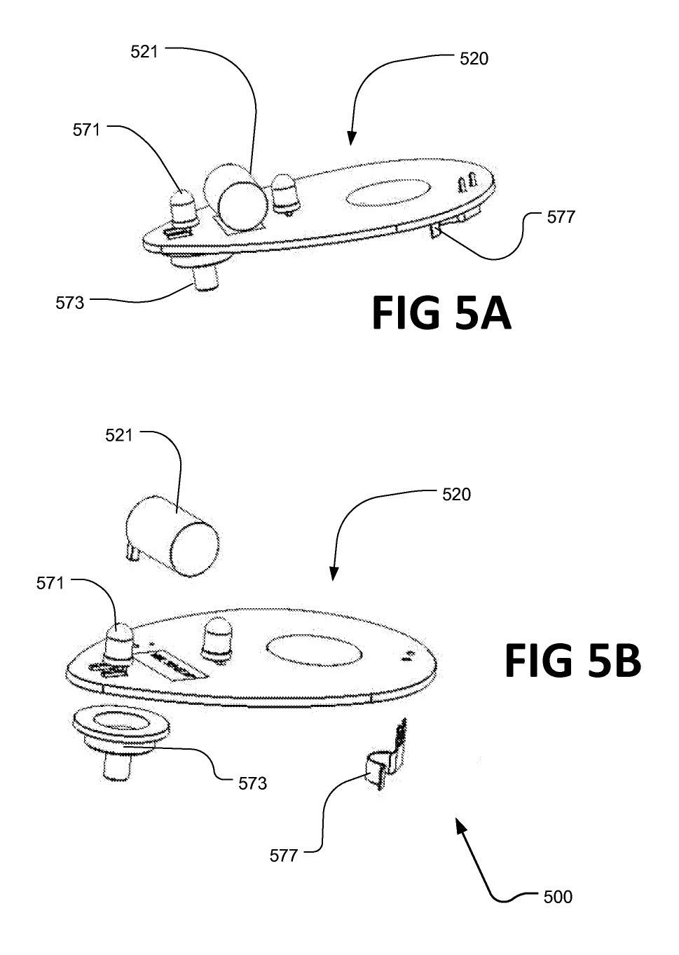

The exercise encouragement device 200 depicted in FIG. 2 illustrates the upper case 210 and how it works in combination with the lower case 230 to protect and contain the internal components of the device 200. The upper case 210 has a plurality of sound holes (see FIG. 1, item 117) in proximity to the sound device 222 that is located inside the exercise encouragement device 200. In the embodiment shown in FIG. 2, the sound device 222 is shown as being located above the printed circuit board (PCB) 220. In other embodiments, the sound device 222 is located under the PCB 220 and under the plurality of sound holes in the upper case 210. The PCB 220 contains a number of electrical components and circuit pathways that work together with the sound device 222 to produce the lights and sounds that encourage the wearer to exercise. For specific components, see FIGS. 5A and 5B. The lower case 230 attaches to the upper case 210 and helps to protect and contain the inner components.

The circuit board 220 is in electrical communication with the other electronic components such as the power source 232, speaker 222, light source 571, vibration sensor switch 521, and power switch 573.

In proximity to the lower case 230 and preferably attached thereto is the clip portion 250. The clip portion 250 allows the device 200 to be attached to apparel, book bags, shoe laces, and other items that are worn or carried by a person. Between the clip portion 250 and the lower portion 230 is the power source 232 (in this illustration, a button battery) and the spring 234. The spring 234 serves to hold the power source 230 in position and ensures solid electrical contact is made between the components.

The broken lines in FIG. 2 represent the direction in which the various components have been moved in order to affect the exploded view illustrated in FIG. 2 and form no portion of the claimed invention. The broken lines are provided for illustrative purposes only.

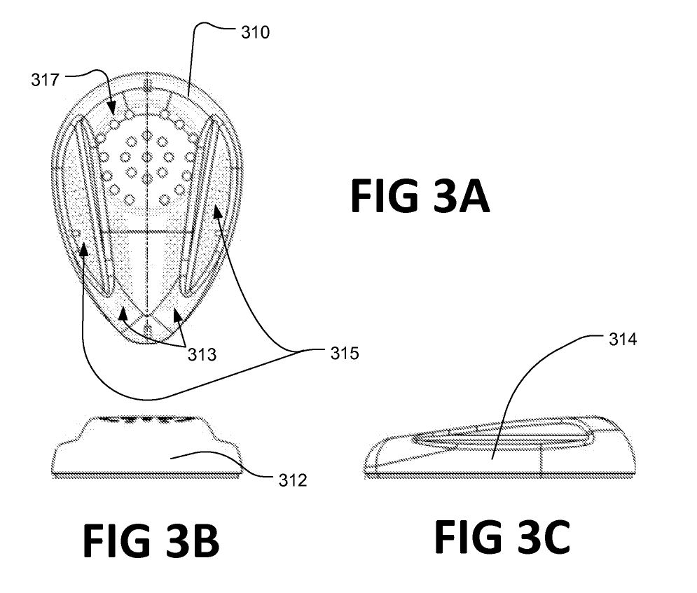

FIG. 3A illustrates a top plan view of an exemplary embodiment of an exercise encouragement device showing the upper case 310 and the sound holes 317. Between the sides of the upper case 310 and the sound holes 317 are two concave surfaces 315. These surfaces 315 provide gripping locations as well as enhancing the number of varying surfaces that can assist the device in producing a brilliant light display. The cross-hatching/shading illustrated in FIG. 3A is an exemplary implementation of reflective/refractive components 313 that can be added in proximity to the light source(s) in order to enhance the flash, dazzle, and visual appeal (i.e., visual stimulation) of light being emitted from the light source(s). In this embodiment, the reflective/refractive components 313 comprise checkering of the inside surface of the upper case 310. Checkering can comprise a series of concave and/or convex lenses, facets, diamond cuts, etc. Other reflective/refractive components 313 are contemplated. Additionally, reflective/refractive components 313 can be added in the concave surfaces 315 to enhance the light display (as shown in FIG. 3A).

FIG. 3B illustrates an elevational view of the top sidewall of an exemplary embodiment of an exercise encouragement device. The top sidewall can be generally rounded in shape as it arcs between the left sidewall (see FIG. 3C) and right sidewall (the right sidewall is a mirror image of the left sidewall). The sound holes (see FIG. 3A, item 317) are just visible as dark sports on the upper case in FIG. 3B and the shape of the concave surfaces 315 of FIG. 3A can be seen in FIG. 3B as well.

FIG. 3C illustrates an elevational view of the left sidewall 314 of an exemplary embodiment of an exercise encouragement device. The right sidewall is not visible in FIG. 3C, but it is approximately a mirror image of the left sidewall 314.

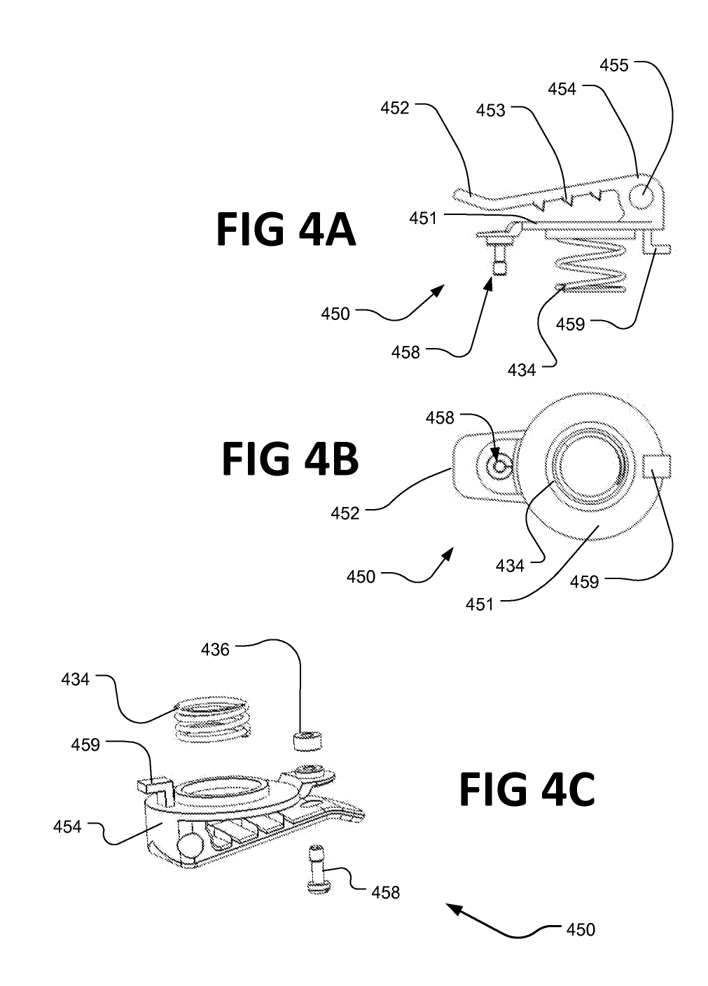

FIG. 4A illustrates an elevational view of the right side of an exemplary embodiment of the clip portion 450 of an exercise encouragement device; the clip portion 450 is shown in an upside down orientation. The clip portion 450 comprises a base 451, an elbow 454, a clasp 452 having a plurality of gripping surfaces 453, a latch tab 459 and an attachment screw 458. The base 451 acts in concert with the clasp 452 to hold items placed therebetween such that the clip portion 450 remains attached to items once correctly positioned.

The gripping surfaces 453 assist in securing items as well (here, the gripping surfaces resemble backwards pointing teeth, other types of gripping surfaces are contemplated). The elbow 454 serves to provide tension between the clasp 452 and base 451 and the elbow 454 also has a lanyard hole 455 in it through which a shoelace, carabiner, lanyard, etc. can be strung to act as an additional attachment means besides the clip portion 450. In other embodiments, no lanyard hole is contemplated. The base 451 has a latch tab 459 that fits into a slot on the lower case. Opposite the latch tab 459 is a screw 458, together they function to secure the clip portion 450 to the lower case. The spring 434 actuates against the power source inside the lower case to ensure proper electrical connection. Turning the screw and removing the clip portion 450 allows access to the power source and replacement thereof.

FIG. 4B illustrates a top plan view of an exemplary embodiment of the clip portion 450 of an exercise encouragement device. The clip portion 450, as shown in FIG. 4B, displays the following components: the base 451, the clasp 452, the spring 434, the latch tab 459, and the screw 458.

FIG. 4C illustrates a perspective view of the right side and top of an exemplary embodiment of the clip portion 450 of an exercise encouragement device. The clip portion 450, as shown in FIG. 4C, displays the following components in more detail: the elbow 454, the screw 458, the spring 434, the latch tab 459, and the screw 458. Also shown is a retaining spacer 436 that goes over the end of the screw 458 before the screw 458 is attached to the lower case.

FIG. 5A illustrates a perspective view of the top of an exemplary embodiment of the PC board 520 of an exercise encouragement device. The printed circuit (PC) board 520 has a vibration sensor switch 521 that is used to sense the movement and acceleration of a child (or other wearer) during energetic activities. Various vibration sensor switches 521 can be utilized. On each side of the switch 521 is a light source (here, red LEDs). Other light sources are contemplated. Underneath the PC board 520 is a power switch 573.

The power switch 573 functions to turn the device on and off. Also, it can be used as a user interface as well. For example, the device can be turned on by initially pressing the power switch 573. This results in a startup sound playing through the speaker and a rapid firing of the LEDs to give a light indication that the unit is on. Now, once the wearer of the device begins to engage in an energetic activity, he or she activates the vibration sensor switch 521 causing the lights to flash alternatively and a sound track to play for approximately eight to twelve seconds. Once the energetic activity ends, the lights and sounds stop in 3 seconds. If there is no additional movement by the wearer, the lights flash every ten seconds (four flashes from one light, alternating with four flashes from the other light, all accomplished in one second). Then ten seconds later, the eight flashes repeat again. The number, duration, and pattern of flashes as well as the number of light sources and periods of time can all vary in other embodiments.

Once the unit is on, pressing the power switch 573 will switch between the available sound tracks (fire truck, race car, horses, puppies and kittens). Other sound tracks can be added via a USB port or other I/O port in other embodiments. Holding down the power switch 523 for more than one second will turn the unit off.

FIG. 5B illustrates a perspective view of the top of an exemplary embodiment of the PC board 520 of an exercise encouragement device. The printed circuit (PC) board 520 has a vibration sensor switch 521 that is used to sense the movement and acceleration of a child (or other wearer) during energetic activities. On each side of the switch 521 is a light source 571. Other light sources are contemplated. Underneath the PC board 520 is a power switch 573. Also shown in FIG. 5B is an electrical connector 577.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. An exercise encouragement device, comprising:
an upper case and a lower case, wherein the upper case attaches to the lower case, and the upper case and the lower case combine to form a combination case that protects and contains a plurality of internal components;
a clip portion attached to the combination case, wherein the clip portion allows the device to be attached to personal items that are on a user's person;
a circuit board and a sound device, wherein the circuit board comprises a plurality of electronics and electrical connections that allow the device to actuate the sound device and to actuate a plurality of light sources;
a power source in electrical communication with the circuit board;
a vibration sensor switch in electrical communication with the circuit board, the vibration sensor switch configured so as to cause at least the sound device to be activated when the vibration sensor senses movement; and
a power switch in electrical communication with the circuit board, the power switch being configured to turn on and off the exercise encouragement device.

2. The exercise encouragement device of claim 1 further comprising a plurality of concave surfaces on the upper case designed to provide a gripping surface.

3. The exercise encouragement device of claim 1 further comprising a plurality of reflective/refractive components configured within the upper case and designed to enhance a visual stimulation created by the plurality of light sources.

4. The exercise encouragement device of claim 2 further comprising a plurality of reflective/refractive components configured within at least the plurality of concave surfaces and designed to enhance a visual stimulation created by the plurality of light sources.

5. The exercise encouragement device of claim 1 further comprising a plurality of reflective/refractive components configured within the lower case and designed to enhance a visual stimulation created by the plurality of light sources.

6. The exercise encouragement device of claim 2 further comprising a plurality of reflective/refractive components configured within the plurality of concave surfaces and within the lower case and designed to enhance a visual stimulation created by the plurality of light sources.

7. The exercise encouragement device of claim 1 wherein the sound device plays at least one of race car sounds, fire truck sounds, horses sounds, puppies sounds and kittens sounds when actuated.

8. The exercise encouragement device of claim 2 wherein the sound device plays at least one of race car sounds, fire truck sounds, horses sounds, puppies sounds and kittens sounds when actuated.

9. The exercise encouragement device of claim 3 wherein the sound device plays at least one of race car sounds, fire truck sounds, horses sounds, puppies sounds and kittens sounds when actuated.

10. The exercise encouragement device of claim 5 wherein the sound device plays at least one of race car sounds, fire truck sounds, horses sounds, puppies sounds and kittens sounds when actuated.

11. The exercise encouragement device of claim 5 wherein the sound device plays at least one of race car sounds, fire truck sounds, horses sounds, puppies sounds and kittens sounds when actuated.

12. The exercise encouragement device of claim 7 wherein the sound device plays at least one of race car sounds, fire truck sounds, horses sounds, puppies sounds and kittens sounds when actuated.
